(19) United States
(12) Patent Application Publication
(10) Pub. No.: US 2003/0118128 A1
(43) Pub. Date: Jun. 26, 2003

(54) Method, system, device and computer program product for a demodulator with communications link adaptation

(76) Inventor: Qilian Liang, San Diego, CA (US)

Correspondence Address: Hughes Electronics Corporation, Patent Docket Administration, Bldg. 1, Mail Stop A109, P.O. Box 956, EI Segundo, CA, 90245-0956, US

(21) Appl. No.: 10/027,734

(22) Filed: Dec. 20, 2001

(51) Int. Cl. H04L 27/22

(52) U.S. Cl. 375/316

(57) ABSTRACT

A method, system, device and computer program product for a demodulator with communications link adaptation, including receiving a modulated signal over the communications channel; extracting clusters from the modulated signal based on an unsupervised clustering technique; computing a mean and standard deviation for each extracted cluster; determining categories for each extracted cluster based on a training sequence included in the modulated signal; and demodulating the modulated signal based on the mean, the standard deviation and the determined categories.

### CROSS REFERENCE TO RELATED DOCUMENTS

The present invention is related to commonly owned U.S. patent application Ser. No. 09/978,291 of Liang et al, entitled “METHOD, DEVICE AND COMPUTER PROGRAM PRODUCT FOR A DEMODULATOR USING A FUZZY ADAPTIVE FILTER (FAF) AND DECISION FEEDBACK,” filed on Oct. 16, 2001 and includes use of various technologies described in the references identified in the appended LIST OF REFERENCES and cross-referenced throughout the specification by numerals in brackets corresponding to the respective references, the entire contents of all of which are incorporated by reference herein.

### BACKGROUND OF THE INVENTION

1. Field of the Invention

The present invention generally relates to satellite communications systems and more A particularly to a method, system, device and computer program product for a demodulator with communications link adaptation. The present invention includes use of various technologies described in the references identified in the appended LIST OF REFERENCES and cross-referenced throughout the specification by numerals in brackets corresponding to the respective references, the entire contents of all of which are incorporated herein by reference.

2. Discussion of the Background

In recent years, with the development of the third-generation (3G) wireless networks, General Packet Radio Services (GPRS) [7] wireless networks are being implemented to support multimedia personal communication services. With these services, people are able to use personal computers (PCs), laptop PCs, personal digital assistants (PDAs), personal information assistants (PIAs), etc., to access multimedia information anywhere. GPRS wireless networks use a short burst format to reduce end-to-end transmission delay. Kim and Cox [4] proposed a dual mode blind equalizer based on a Constant Modulus Algorithm and their scheme is applicable to short burst transmission formats. Viterbi and Viterbi [6] proposed a semi-blind demodulation algorithm, but training sequences are needed to remove the ambiguity of inverse tangent function and the algorithm is typically applicable for only M-ary Phase-Shift Keying (M-PSK).

However, the above techniques typically are not applicable to a plurality of modulation techniques, such as M-PSK, Quadrature Phase Shift Keying (QPSK), Quadrature Amplitude Modulation (QAM), Pulse Amplitude Modulation (PAM), etc., and typically treat link adaptation and demodulation as two separate tasks.

Therefore, there is a need for a method, system, device and computer program product for a demodulator applicable to M-PSK, QPSK, QAM, PAM, etc., and that combines link adaptation and demodulation into one framework.

### SUMMARY OF THE INVENTION

The above and other needs are addressed by the present invention, which provides an improved device, system and computer program product for a demodulator with communications link adaptation that is applicable to a plurality of modulation techniques, such as M-ary Phase-Shift Keying (M-PSK), Quadrature Phase Shift Keying (QPSK), Quadrature Amplitude Modulation (QAM), Pulse Amplitude Modulation (PAM), etc., as compared to conventional demodulators.

Accordingly, in one aspect of the present invention there is provided an improved method, system, device and computer program product for a demodulator with communications link adaptation, including receiving a modulated signal over the communications channel; extracting clusters from the modulated signal based on an unsupervised clustering technique; computing a mean and standard deviation for each extracted cluster; determining categories for each extracted cluster based on a training sequence included in the modulated signal; and demodulating the modulated signal based on the mean, the standard deviation and the determined categories.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a system diagram illustrating an exemplary satellite communications system, which may employ a demodulator with communications link adaptation, according to the present invention;

FIG. 2 is a block diagram illustrating a demodulator with communications link adaptation, which may be used in the system of FIG. 1, according to the present invention;

FIG. 3 is a block diagram of a system model used to evaluate the performance of the demodulator with communications link adaptation of FIG. 2, according to the present invention;

FIG. 4 is a diagram illustrating a burst format used in GPRS wireless networks, according to the present invention;

FIG. 5 is a flow chart illustrating the operation of the demodulator with communications link adaptation of FIG. 2, according to the present invention;

FIGS. 6a and 6b are graphs illustrating the performance of the demodulator with communications link adaptation of FIG. 2, (a) RMSE in terms of mean and (b) RMSE in terms of std, according to the present invention;

FIG. 7 is a graph illustrating the performance of the demodulator with communications link adaptation of FIG. 2 with respect to error of SQI estimation, according to the present invention;

FIG. 8 is a graph illustrating the performance of the demodulator with communications link adaptation of FIG. 2 and a BPE-based demodulator when the Rician factor K=9 dB and f_{d}=10 Hz, according to the present invention; and

FIG. 9 is an exemplary computer system, which may be programmed to perform one or more of the processes of the present invention.

### DETAILED DESCRIPTION OF THE PREFERRED EMBODIMENTS

A device, method and computer program product for a demodulator with communications link adaptation, are described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

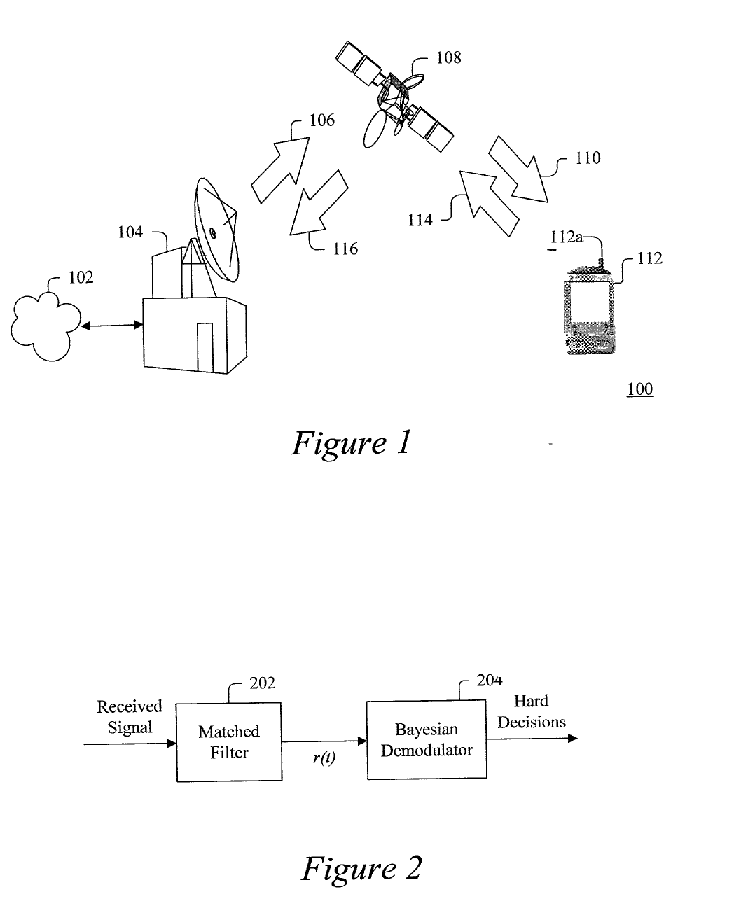

Referring now to the drawings, wherein like reference numerals designate identical or corresponding parts throughout the several views, and more particularly to FIG. 1 thereof, there is illustrated a system 100 in which a demodulator with communications link adaptation according to the present invention may be employed. In FIG. 1, in the system 100 according to the present invention, a network operations control center 104 transmits information on satellite uplink channel 106, such as received from sources 102 (e.g., the Internet, an Intranet, content sources, etc.), to a satellite 108. The satellite 108 then transmits modulated information (e.g., using Quadrature Phase Shift Keying (QPSK), etc.) on a device downlink channel 110 to a device 112, such as a personal digital assistant (PDA), a personal information assistant (PIA), a personal computer (PC), a laptop PC, a television, an Internet appliance, a cellular phone, a set-top box, etc.

The device 112 includes an antenna 112a and a satellite communications transceiver (not shown) and thus is able to receive the modulated information on the downlink channel 110. Such a satellite communications transceiver may include the demodulator with communications link adaptation according to the present invention, as will be further described in detail with respect to FIG. 2, to demodulate the information received on the downlink channel 110.

The device 112 may make requests for information and/or transmit information via a device uplink channel 114. The satellite 118 receives information transmitted from the device 112 on the device uplink channel 114 and transmits the received information to the network operations control center 104 via a satellite downlink channel 116. The network operations control center 104 then may forward the information received on the satellite downlink channel 116 from the satellite 118 to the sources 102 (e.g., the Internet, an Intranet, content sources, etc.).

With the above-noted system 100, video download, audio download, graphics download, file download, pay per view, video-on-demand, audio-on-demand, Internet surfing, e-mail, voice communications, text communications, paging functions, etc., may be implemented on the device 112. One or more interface mechanisms may be used in the system 100, for example, including Internet access, telecommunications in any form (e.g., voice, modem, etc.), wireless communications media, etc., via the communication network 104 and the satellite communications channels 106, 110, 114, and 116. The system 100 information also may be transmitted via direct mail, hard copy, telephony, etc., when appropriate.

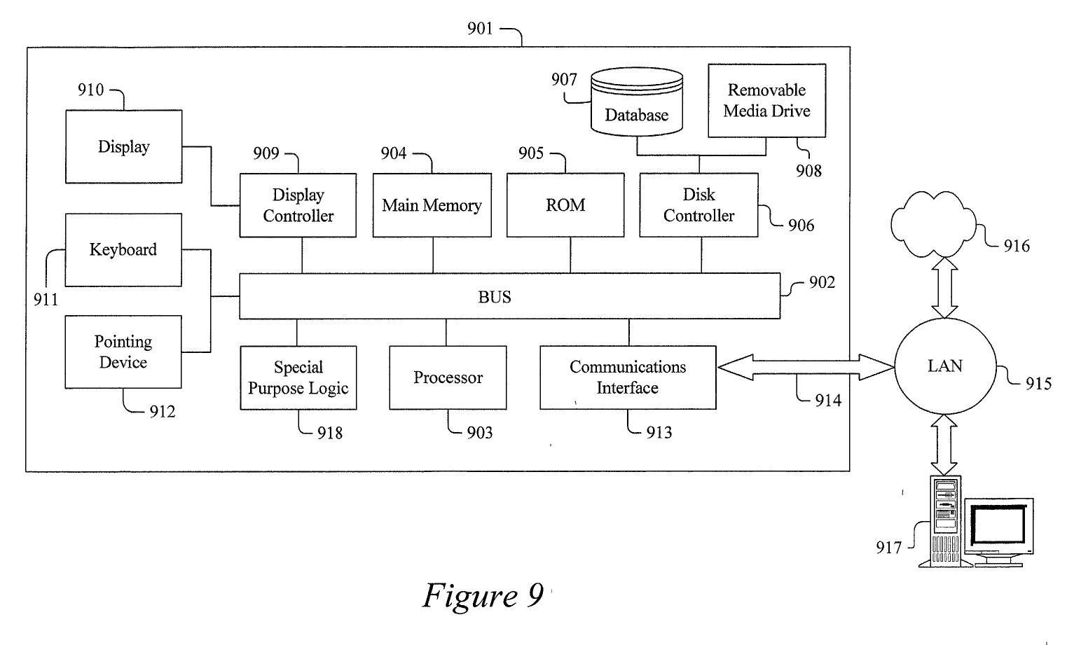

Accordingly, the systems 104, 108 and 112 may include any suitable servers, workstations, personal computers (PCs), laptop PCs, personal digital assistants (PDAs), Internet appliances, set top boxes, other devices, etc., capable of performing the processes of the present invention. The systems 104, 108 and 112 may communicate with each other using any suitable protocol and, for example, via the communications network 102 and the communications channels 106, 110, 114 and 116 and may be implemented using the computer system 901 of FIG. 9, for example.

It is to be understood that the system in FIG. 1 is for exemplary purposes only, as many variations of the specific hardware used to implement the present invention are possible, as will be appreciated by those skilled in the relevant art(s). For example, the functionality of the one or more of the systems 104 and 108 may be implemented via one or more programmed computers or devices. To implement such variations as well as other variations, a single computer (e.g., the computer system 901 of FIG. 9) may be programmed to perform the special purpose functions of, for example, the systems 104 and 108 shown in FIG. 1. On the other hand, two or more programmed computers or devices, for example as in shown FIG. 9, may be substituted for any one of the systems 104, 108 and 112. Principles and advantages of distributed processing, such as redundancy, replication, etc., may also be implemented as desired to increase the robustness and performance of the system 100, for example.

The communications network 102 may be implemented via one or more communications networks (e.g., the Internet, an Intranet, a wireless communications network, a satellite communications network, a cellular communications network, a hybrid network, etc.), as will be appreciated by those skilled in the relevant art(s). In a preferred embodiment of the present invention, the communications network 102 and the communications channels 106, 110, 114 and 116 and the systems 104, 108 and 112 preferably use electrical, electromagnetic, optical signals, etc., that carry digital data streams, as are further described with respect to FIG. 9. The demodulator according to the present invention will now be described in detail in the following sections and with reference to FIGS. 1-9.

FIG. 2 is a block diagram illustrating a demodulator 204 with communications link adaptation, which may be used in the system of FIG. 1, according to the present invention. A matched filter 202 receives a signal over the communications channel 110 and outputs a filtered signal r(t). The signal r(t) filtered by the matched filter 202 is then passed to the demodulator 204 with communications link adaptation. The demodulator 204 with communications link adaptation receives the filtered signal r(t) and demodulates (e.g., using Bayesian demodulation techniques, etc.) the filtered signal r(t) to generate hard decisions used downstream, for example, for burst extraction, payload extraction, etc. The operation of the demodulator 204 of the present invention with communications link adaptation will now be described in detail.

Generally, the demodulator 204 of the present invention may be employed in a wireless communications network, such as a satellite-based time-division-multiple-access (TDMA) GPRS wireless network of FIG. 1. It is assumed that there is only one path (i.e., Rician flat fading) in the satellite device downlink channel 110, which is quite common for satellite communications. In such an application, for example, a Bayesian demodulation scheme, etc., may be used in the demodulator 204 in, for example, GPRS wireless communications. The demodulator 204 adaptively estimates the parameters for link adaptation. The demodulator 204 demodulates a received signal distorted by Rician fading based on, for example, one GPRS burst. An important parameter for link adaptation is signal-to-noise ratio (SNR) known as signal quality indicator (SQI). Most modulator designs treat link adaptation and demodulation as two separate tasks. The present invention, however, unifies link adaptation and demodulation into one framework. A Gaussian distribution may approximate the physical channel of a satellite-based GPRS network. Then, according to the present invention, for example, a Bayesian classifier may be applied to the demodulator 204 design based on such approximation. The signal and noise levels are adaptively estimated using unsupervised clustering, such as Fuzzy c-Means (FCM), etc., as will now be described.

### UNSUPERVISED CLUSTERING—FUZZY C-MEANS (FCM)

FCM clustering is a data clustering technique, wherein each data point belongs to a cluster to a degree specified by a membership grade. This technique was originally introduced by Bezdek [2] as an improvement on earlier clustering methods. FCM clustering by will now be briefly summarized.

Definition 1 (Fuzzy c-Partition):

Let X=x₁, x₂, . . . , xₙ be any finite set, V_{cn} be the set of real c×n matrices, and c be an integer, where 2≦c<n. The Fuzzy c-partition space for X is the set:

$${M}_{fc} = U ∈ {V}_{cn} \vert {u}_{ik} ε [ 0 , 1 ] ∀ i , k ; \\ where {\sum }_{i = 1}^{c} {u}_{ik} = 1 ∀ k and 0 < {\sum }_{k = 1}^{n} {u}_{ik} < n ∀ i \qquad ( 1 )$$

The row i of matrix U∈M_{fc} contains values of the ith membership function, uᵢ, in the fuzzy c-partition U of X.

Definition 2 (Fuzzy c-Means Functionals) [2]:

Let Jₘ: M_{fc}×R^{cp}→R⁺ be:

$${J}_{m} ( U , v ) = {\sum }_{k = 1}^{n} {\sum }_{i = 1}^{c} {( {u}_{ik} )}^{m} {( {d}_{ik} )}^{2} \qquad ( 2 )$$

where U∈M_{fc} is a fuzzy c-partition of X; v=(v₁, v₂ . . . , v_{c})∈R^{cp}, where vᵢ∈R^{p}, is the cluster center of prototype uᵢ, 1≦i≦c;

(dᵢₖ)²=∥xₖ−vᵢ∥² (3)

where ∥•∥ is any inner product induced norm on R^{p}; weighting exponential m∈[1, ∞); uᵢₖ is the membership of xₖ in fuzzy cluster uᵢ; and Jₘ(U, v) represents the distance from any given data point to a cluster weighted by that point's membership grade.

The solutions of:

$${min}_{U ∈ {M}_{fc} , v ∈ {R}^{cp}} {J}_{m} ( U , v ) \qquad ( 4 )$$

are least-squared error stationary points of Jₘ. An infinite family of fuzzy clustering algorithms, one for each m∈(1, ∞), is obtained using the necessary conditions for solutions of equation (4), as summarized by the following Theorem:

Theorem 1 [2]:

Assume ∥•∥ to be an inner product induced norm: fix m∈(1, ∞), let X have at least c<n distinct points, and define the sets (∀k).

Iₖ={i|1≦i≦c; dᵢₖ=∥xₖ−vᵢ∥=0} (5)

Ĩₖ={1, 2, . . . , c}−Iₖ (6)

Then (U, v)∈M_{fc}×R^{cp} is globally minimal for Jₘ only if (wherein φ denotes an empty set):

$$\begin{matrix}{I}_{k} = φ ⇒ {u}_{ik} = 1 / [ {\sum }_{j = 1}^{c} {( \frac{{d}_{ik}}{{d}_{jk}} )}^{2 / ( m - 1 )} ] or & ( 7 ) \\ {I}_{k} \neq φ ⇒ {u}_{ik} = 0 ∀ I ∈ {\tilde{I}}_{k} and {\sum }_{i ∈ {I}_{k}} {u}_{ik} = 1 , and & ( 8 ) \\ {v}_{i} = {\sum }_{k = 1}^{n} {( {u}_{ik} )}^{m} {x}_{k} / {\sum }_{k = 1}^{n} {( {u}_{ik} )}^{m} ∀ i & ( 9 )\end{matrix}$$

Bezdek proposed the following iterative method [2] to minimize Jₘ(U, v):

1. Fix c, 2≦c<n; choose any inner product norm metric for R^{p}; and fix m, 1≦m<∞. Initialize U⁽⁰⁾∈M_{fc} (e.g., choose its elements randomly from the values between 0 and 1). Then at step l(l=1, 2, . . . ):

2. Calculate the c fuzzy cluster centers vᵢ^{(l)} using equation (9) and U^{(l)}.

3. Update U^{(l)} using equations (7) or (8).

4. Compare U^{(l)} to U^{(l-1)} using a convenient matrix norm, i.e., if ∥U^{(l)}−U^{(l-1)}∥≦ε_{L} stop; otherwise, return to step 2.

The present invention may apply the FCM method to cluster, for example, one GPRS burst cell to 4 clusters. This is because, for example, Quadrature Phase Shift Keying (QPSK) modulation is used. The details are presented in the following section. However, the FCM method may be applied to other types of modulation techniques, such as M-ary Phase-Shift Keying (M-PSK), Quadrature Amplitude Modulation (QAM), Pulse Amplitude Modulation (PAM), etc., as will be appreciated by those skilled in the relevant art(s).

### SYSTEM MODEL

A satellite channel is often modeled as a Rician fading channel. Rician fading occurs when there is a strong specular (i.e., direct path or line of sight component) signal in addition to the scatter (i.e., multipath) components. The channel gain:

g(t)=g_{I}(t)+jg_{Q}(t) (10)

may be treated as a wide-sense stationary complex Gaussian random process, wherein g_{I}(t) and g_{Q}(t) may be Gaussian random processes with non-zero means m_{I}(t) and m_{Q}(t), respectively. Because g_{I}(t) and g_{Q}(t) may have a same variance σ_{g}², the magnitude of the received complex envelope may have a Rician distribution [5]:

$${p}_{α} ( x ) = \frac{x}{{σ}^{2}} exp \{ - \frac{{x}^{2} + {s}^{2}}{2 {σ}^{2} } \} {I}_{0} ( \frac{xs}{{σ}^{2}} ) x \geq 0 \qquad ( 11 )$$

where:

s²=m_{I}²(t)+m_{Q}²(t) (12)

and I₀(•) may be a zero order modified Bessel function.

Such a channel may be known as a Rician fading channel. A Rician channel typically is characterized by two parameters, Rician factor K, which is the ratio of the direct path power to that of the multipath, i.e., K=s²/2σ² [5] and the Doppler spread (or single-sided fading bandwidth) f_{d}. The Rician fading may be simulated using a direct path added by a Rayleigh fading generator. The Rayleigh fade generator may be based on Jakes' model [3] in which an ensemble of sinusoidal waveforms are added together to simulate the coherent sum of scattered rays with Doppler spread f_{d} arriving from different directions to the receiver. The amplitude of the Rayleigh fade generator is controlled by the Rician factor K. The number of oscillators to simulate the Rayleigh fading is, for example, 60.

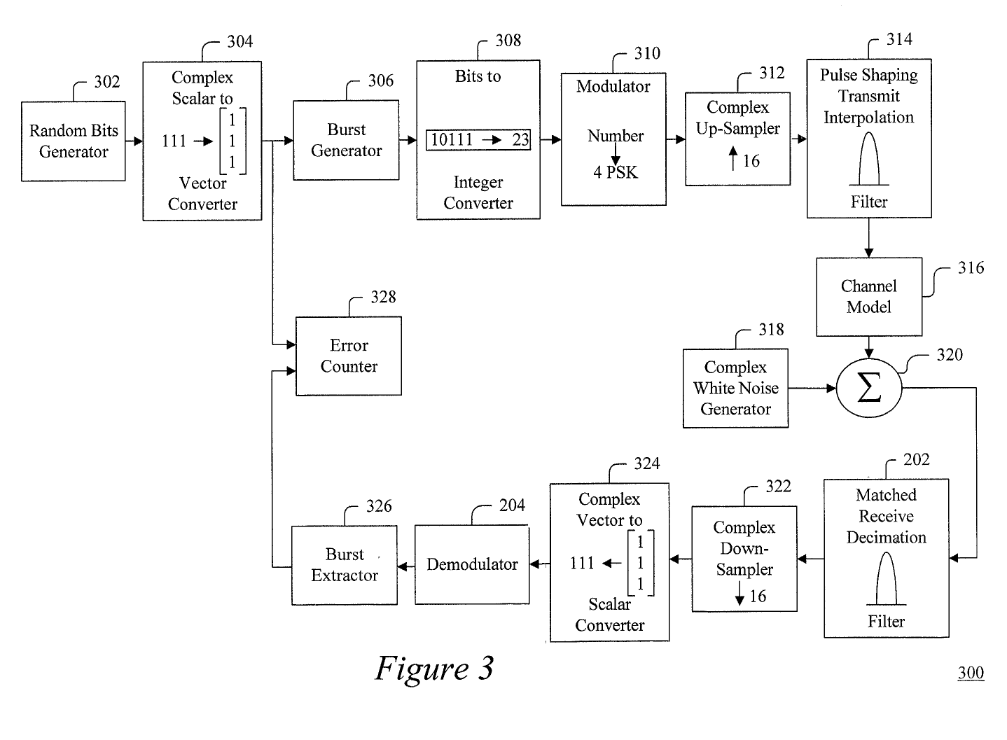

In the present invention, a system model 300, corresponding to the system 100 of FIG. 1, as shown in FIG. 3, may be used for simulation (e.g., using Mathcad by MathSoft Engineering & Education, Inc., etc.). In FIG. 3, the system model for the transmitter (e.g., provided in the satellite 108) may include a random bits generator 302, a scalar-to-vector converter 304, a burst generator 306, a bits to integer converter 308, a modulator 310, an up-sampler (e.g., by 16) 312, a pulse shaping filter 314 (e.g., a square root raised cosine filter with roll off factor 0.35), and output of a Rician fading channel model 316 summed via summer 320 with output of a complex white noise generator 318. The system model for the receiver (e.g., provided in the device 112) may include the matched filter 202, a down-sampler 322 (e.g., by 16), a vector-to-scalar converter 324, the demodulator 204 (e.g., Bayesian, etc.), a burst extractor 326 and a bit error counter 328.

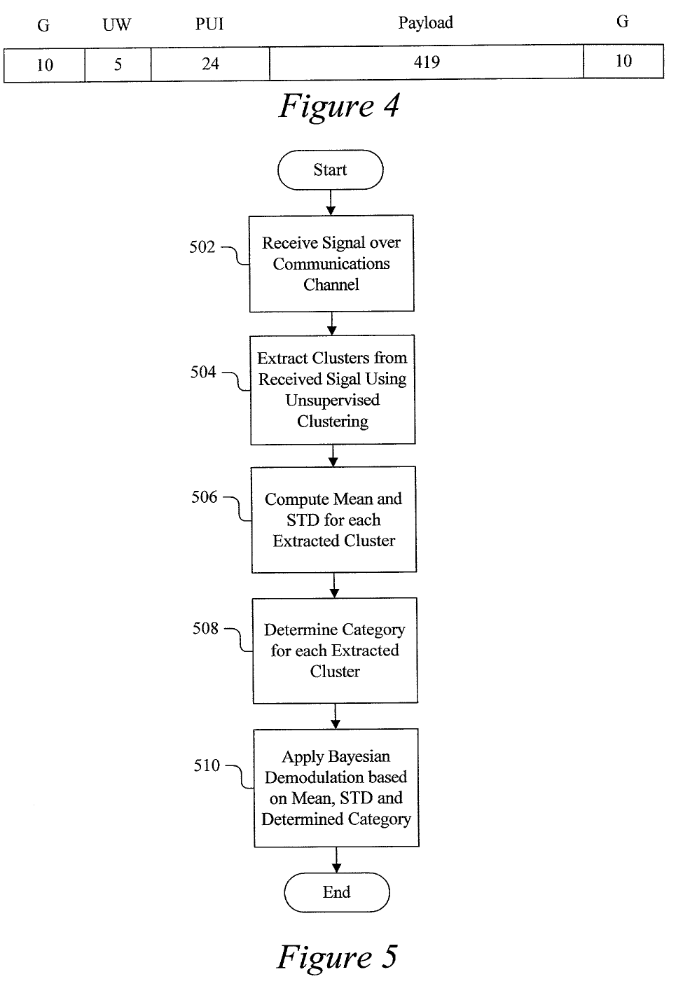

In FIG. 4, a burst format used is shown. In FIG. 4, the burst format may include, for example, 468 QPSK symbols per burst, 10 guard symbols at the beginning and end of the burst; 5 symbols including unique words (Uws, also referred to as a “training sequence,” “synchronization words,” etc.) for training; 24 public user information (PUI) symbols and 419 symbols for payload. The random bits generator 302 generates, for example, a binary data stream with equally likely zeros and ones, which may be used for the payload bits (e.g., 838 bits). The burst builder 306 may insert some header and control bits and make a complete burst with, for example, 936 bits. The bits then are modulated to, for example, 468 QPSK symbols via the modulator 310.

### LINK ADAPTATION AND BAYESIAN DEMODULATOR FOR GPRS

Theoretical Basis

The matched filter 202 output when sampled in time-synchronization may be modeled as:

r(t)=g(t)s(t)+n(t) (13)

where:

n(t)=n_{I}(t)+jn_{Q}(t) (14)

is additive white Gaussian noise (AWGN) with mean of 0 and variance σₙ² in the in-phase (I) and quadrature (Q) components. For QPSK modulation, s(t)∈{1, j, −1, −j} may be the signal points. Based on different values of s(t), the following results may be derived:

1. If s(t)=1, then:

$$\begin{matrix}r ( t ) = g ( t ) + n ( t ) & ( 15 ) \\ = {g}_{I} ( t ) + {jg}_{Q} ( t ) + {n}_{I} ( t ) + {jn}_{Q} ( t ) & ( 16 ) \\ = [ {g}_{I} ( t ) + {n}_{I} ( t ) ] + j [ {g}_{Q} ( t ) + {n}_{Q} ( t ) ] & ( 17 )\end{matrix}$$

Since both g_{I}(t) and n_{I}(t) may be Gaussian distributions with mean m_{I}(t) and 0 and with variance σ_{g}² and σₙ², respectively,

$${r}_{I} ( t ) {=}^{Δ} {g}_{I} ( t ) + {n}_{I} ( t )$$

may be a Gaussian distribution with mean m_{I}(t) and variance σ_{g}²+σₙ² [1]. Similarly,

$${r}_{Q} ( t ) {=}^{Δ} {g}_{Q} ( t ) + {n}_{Q} ( t )$$

may be a Gaussian distribution with mean m_{Q}(t) and variance σ_{g}²+σₙ².

2. If s(t)=j:

$$\begin{matrix}r ( t ) = jg ( t ) + n ( t ) & ( 18 ) \\ = - {g}_{Q} ( t ) + {jg}_{I} ( t ) + {n}_{I} ( t ) + {jn}_{Q} ( t ) & ( 19 ) \\ = [ - {g}_{Q} ( t ) + {n}_{I} ( t ) ] + j [ {g}_{I} ( t ) + {n}_{Q} ( t ) ] & ( 20 )\end{matrix}$$

then

$${r}_{I} ( t ) {=}^{Δ} - {g}_{Q} ( t ) + {n}_{I} ( t )$$

may be a Gaussian distribution with mean −m_{Q}(t) and variance σ_{g}²+σₙ² and

$${r}_{Q} ( t ) {=}^{Δ} {g}_{I} ( t ) + {n}_{Q} ( t )$$

may be a Gaussian distribution with mean m_{I}(t) and variance σ_{g}²+σₙ².

3. If s(t)=−1:

$$\begin{matrix}r ( t ) = - g ( t ) + n ( t ) & ( 21 ) \\ = - {g}_{I} ( t ) - {jg}_{Q} ( t ) + {n}_{I} ( t ) + {jn}_{Q} ( t ) & ( 22 ) \\ = [ - {g}_{I} ( t ) + {n}_{I} ( t ) ] + j [ - {g}_{Q} ( t ) + {n}_{Q} ( t ) ] & ( 23 )\end{matrix}$$

then

$${r}_{I} ( t ) {=}^{Δ} - {g}_{I} ( t ) + {n}_{I} ( t )$$

may be a Gaussian distribution with mean −m_{I}(t) and variance σ_{g}²+σₙ² and

$${r}_{Q} ( t ) {=}^{Δ} - {g}_{Q} ( t ) + {n}_{Q} ( t )$$

may be a Gaussian distribution with mean −m_{Q}(t) and variance σ_{g}²+σₙ².

4. If s(t)=−j:

$$\begin{matrix}r ( t ) = - jg ( t ) + n ( t ) & ( 24 ) \\ = {g}_{Q} ( t ) - {jg}_{I} ( t ) + {n}_{I} ( t ) + {jn}_{Q} ( t ) & ( 25 ) \\ = [ {g}_{Q} ( t ) + {n}_{I} ( t ) ] + j [ - {g}_{I} ( t ) + {n}_{Q} ( t ) ] & ( 26 )\end{matrix}$$

then

$${r}_{I} ( t ) {=}^{Δ} {g}_{Q} ( t ) + {n}_{I} ( t )$$

may be a Gaussian distribution with mean m_{Q}(t) and variance σ_{g}²+σₙ² and

$${r}_{Q} ( t ) {=}^{Δ} - {g}_{I} ( t ) + {n}_{Q} ( t )$$

may be a Gaussian distribution with mean −m_{I}(t) and variance σ_{g}²+σₙ².

Summarizing the above results, for r(t)=r_{I}(t)+jr_{Q}(t), equations (27) may be obtained, as follows:

r_{I}(t)˜N(•;m_{I}(t), σ_{g}²+σₙ²), r_{Q}(t)˜N(•;m_{Q}(t), σ_{g}²+σₙ²), if s(t)=1

r_{I}(t)˜N(•;−m_{Q}(t), σ_{g}²+σₙ²), r_{Q}(t)˜N(•;m_{I}(t),σ_{g}²+σₙ²), if s(t)=j

r_{I}(t)˜N(•;−m_{I}(t), σ_{g}²+σₙ²), r_{Q}(t)˜N(•;−m_{Q}(t), σ_{g}²+σₙ²), if s(t)=−1

r_{I}(t)˜N(•;m_{Q}(t), σ_{g}²+σₙ²), r_{Q}(t)˜N(•;−m_{I}(t), σ_{g}²+σₙ²), if s(t)=−j

where N(•; m, σ²) may denote a Gaussian distribution with mean m and variance σ². Accordingly, the received signals of one burst may be clustered to four clusters and the signals associated with each cluster may have a Gaussian distribution. The mean (i.e., time average) and variance of each cluster then may be used to compute the signal and noise level, i.e., to estimate the SQI and the demodulator 204 (e.g., Bayesian, etc.) may be implemented based on this technique.

### ESTIMATION OF THE SQI AND DESIGN OF THE BAYESIAN DEMODULATOR

Determining the Mean, Variance, SQI, and Cluster Category

There may be, for example, 5 QPSK symbols that may be used to determine the category of each cluster. Suppose the 5 QPSK symbols are all 1's. In this case, the FCM method may be used to cluster the 468 symbols (i.e., one burst) into c=4 clusters, wherein each cluster has the mean (vᵢ, i=1, 2, 3, 4). The FCM method may also generate U, a 4×468 matrix in such application. Every received symbol rₖ (k=1, 2, . . . , 468) may have four membership grades

$${u}_{ik} ε U ( i = 1 , 2 , 3 , 4 and {\sum }_{i = 1}^{4} {u}_{ik} = 1 )$$

corresponding to the four clusters. Based on the four values of uᵢₖ (i=1, 2, 3, 4) for each k, which cluster each symbol belongs to maybe determined based on the maximum membership in uᵢₖ (i=1, 2, 3, 4). Accordingly, a the 468 symbols may be clustered to 4 clusters using such a hard decision, which may be generated by the demodulator 204.

The variance of each cluster is computed based on such decision. The SQI may be estimated using:

$$\begin{matrix}\frac{{\hat{E}}_{b}}{{\hat{N}}_{0}} = \frac{\frac{1}{2} {\hat{E}}_{s}}{{\hat{N}}_{0}} & ( 28 ) \\ = 10 {log}_{10} \frac{1}{2} \frac{1}{4 N} {\sum }_{n = 1}^{N} \frac{{\sum }_{i = 1}^{4} ( {m}_{in} {I}^{2} + {m}_{in} {Q}^{2} )}{\frac{1}{4 N} {\sum }_{n = 1}^{N} {\sum }_{i = 1}^{4} ( {σ}_{in} {I}^{2} + {σ}_{in} {Q}^{2} )} & ( 29 ) \\ = 10 {log}_{10} {\sum }_{n = 1}^{N} \frac{{\sum }_{i = 1}^{4} ( {m}_{in} {I}^{2} + {m}_{in} {Q}^{2} )}{2 {\sum }_{n = 1}^{N} {\sum }_{i = 1}^{4} ( {σ}_{in} {I}^{2} + {σ}_{in} {Q}^{2} )} & ( 30 )\end{matrix}$$

where [mᵢₙI, mᵢₙQ], and [σᵢₙI, σᵢₙQ] may denote the estimated mean and standard deviation (std) of the I and Q components of the ith cluster in the nth burst, respectively.

Based on the cluster where the normalized UW signal has been assigned (i.e., based on the maximum membership), such a cluster may be assigned to the category “1.” Because of the channel fading and randomness of the noise, normalized UW signals may be clustered to different clusters and majority logic may be used to determine which cluster may be assigned to the category “1.” Once the cluster with category “1” is determined, the remaining three clusters may be assigned to the “j”, “−1”, and “−j” categories, for example, in a counterclockwise order from the cluster assigned category “1.”

Bayesian Demodulator Computation Formula

Bayesian detection may then be applied to every signal point in the burst using the following rule:

The signal r(t) may given by aᵢ (i=1, 2, 3, 4), where aᵢ∈{1, j, −1, −j} if:

p(r(t)|s(t)=aᵢ)>p(r(t)|s(t)=aⱼ) ∀aⱼ≠aᵢ (31)

To compute

$$p ( r ( t ) \vert s ( t ) = {a}_{i} ) , r {\underline{\underline{Δ}} [ {r}_{I} ( t ) , {r}_{Q} ( t ) ]}^{T}$$

may be given by:

$$\begin{matrix}p ( r ( t ) \vert s ( t ) = {a}_{i} ) = p ( r \vert {a}_{i} ) & ( 32 ) \\ = \frac{1}{( 2 π ) \vert {\sum }_{i} {\vert}^{1 / 2}} exp [ - \frac{1}{2} {( r - {m}_{i} )}^{τ} {\sum }_{i}^{- 1} ( r - {m}_{i} ) ] & ( 33 )\end{matrix}$$

where

$${m}_{i} {\underline{\underline{Δ}} [ {m}_{i}^{I} , {m}_{i}^{Q} ]}^{T}$$

and Σ_{I}=diag{σ_{g}²+σₙ², σ_{g}²+σₙ²} are the mean vector (2×1) and covariance matrix (2×2) of [r_{I}(t), r_{Q}(t)]^{T}.

FIG. 5 is a flow chart illustrating the operation of the demodulator 204 with communications link adaptation of FIG. 2, according to the present invention. In FIG. 5, at step 502, the demodulator 204 receives the signal r(t) from the matched filter 202 based on the signal received over the device downlink channel 110 by the matched filter 202. At step 504, clusters are extracted from the received signal r(t) using unsupervised clustering, such as FCM, etc., as previously described. At step 506, the mean and standard deviation are computed for each extracted cluster, as previously described. At step 508, a category for each extracted cluster (e.g., “1,” “j”, “−1”, and “−j” for QPSK modulation) is determined, as previously described. At step 510, demodulation (e.g., Bayesian, etc.) is performed based on the computed mean, standard deviation and determined category to generate the hard decisions, as previously described, completing the operation.

### SIMULATIONS

For simulation purposes, a Rician fading channel with, for example, a Rician factor K=9 dB, a Doppler shift f_{d}=10 Hz and symbol rate 93.6 ks/s (i.e., 5 ms per burst) may be used. The information (i.e., payload) bit rate of 167.6 kb/s may be used. How well the FCM algorithm works in estimating the mean and variance for the four clusters (i.e., in QPSK modulation) may be evaluated in terms of root-mean-square-error (RMSE), which may be defined as:

$$\begin{matrix}{RMSE}_{m} = \sqrt{\frac{1}{4 N} {\sum }_{n = 1}^{N} {\sum }_{i = 1}^{4} [ {( {\hat{m}}_{in} I - {\hat{m}}_{in} I )}^{2} + {( {\hat{m}}_{in} Q - {m}_{in} Q )}^{2} ]} & ( 34 ) \\ {RMSE}_{std} = \sqrt{\frac{1}{4 N} {\sum }_{n = 1}^{N} {\sum }_{i = 1}^{4} {( {\hat{σ}}_{in} I - {\hat{σ}}_{in} I )}^{2} + {( {\hat{σ}}_{in} Q - {σ}_{in} Q )}^{2} ]} & ( 35 )\end{matrix}$$

where [mˆ ᵢₙI, mˆ ᵢₙQ] and [σˆ ᵢₙI, σˆ ᵢₙQ] denote the estimated mean and standard deviation (std) of the I and Q components of the ith cluster in the nth cell respectively; [mᵢₙI, mᵢₙQ] and [σᵢₙI, σᵢₙQ] are the actual mean and std of the I and Q components (i.e., obtained via supervised clustering in which we typically know the exact category of received signal) of the ith cluster in the nth cell, respectively; and N is the total number of cells.

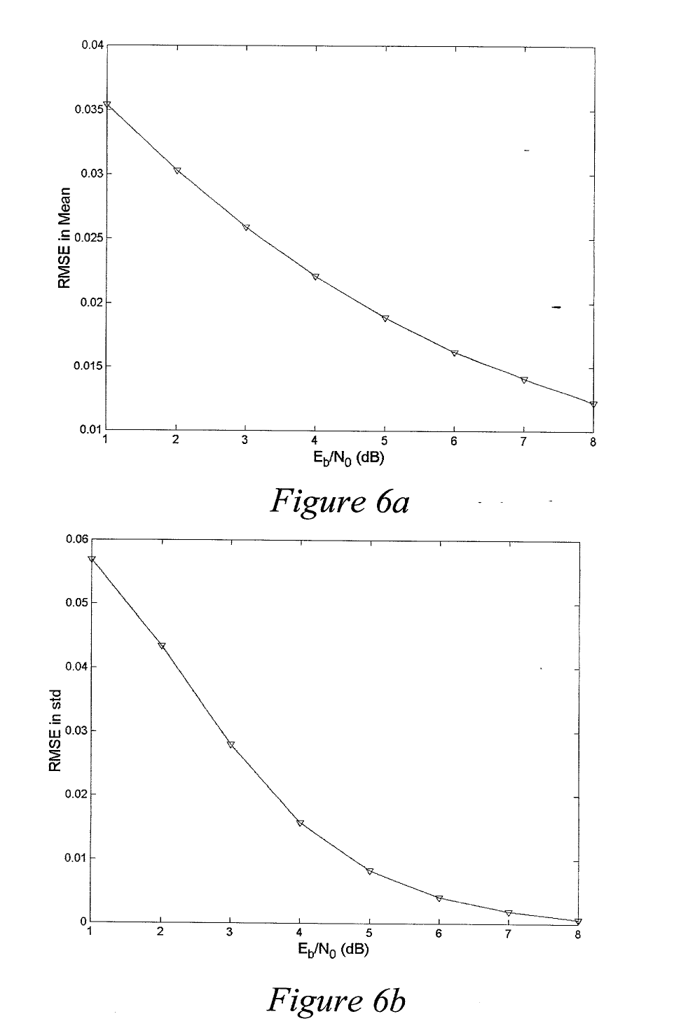

FIGS. 6a and 6b are graphs showing the performance (i.e., RMSEₘ and RMSE_{std}) of FCM clustering for 5,000 cells at each E_{b}/N₀ (dB) value, which may be defined as:

$$\begin{matrix}\frac{{E}_{h}}{{N}_{0}} = \frac{\frac{1}{2} {E}_{s}}{{N}_{0}} = 10 {log}_{10} \frac{\frac{1}{2} \frac{1}{4 N} {\sum }_{n = 1}^{N} {\sum }_{i = 1}^{4} ( {m}_{in} {I}^{2} + {m}_{in} {Q}^{2} )}{\frac{1}{4 N} {\sum }_{n = 1}^{N} {\sum }_{i = 1}^{4} ( {σ}_{in} {I}^{2} + {σ}_{in} {Q}^{2} )} & ( 36 ) \\ = 10 {log}_{10} \frac{{\sum }_{n = 1}^{N} {\sum }_{i = 1}^{4} ( {m}_{in} {I}^{2} + {m}_{in} {Q}^{2} )}{2 {\sum }_{n = 1}^{N} {\sum }_{i = 1}^{4} ( {σ}_{in} {I}^{2} + {σ}_{in} {Q}^{2} )} & ( 37 )\end{matrix}$$

The simulation system 300 may be calibrated and the average signal power Eₛ may be normalized to 1 before the demodulator 204. From FIGS. 6a and 6b, it is observed that both RMSEₘ and RMSE_{std} are quite small, which means that the mean and variance of the received symbols obtained via the FCM approaches those obtained via supervised clustering. Accordingly, when the symbol categories of received signals are unknown, FCM clustering may be used to extract the mean and variance of four clusters, which makes the optimal (Bayesian) demodulation possible.

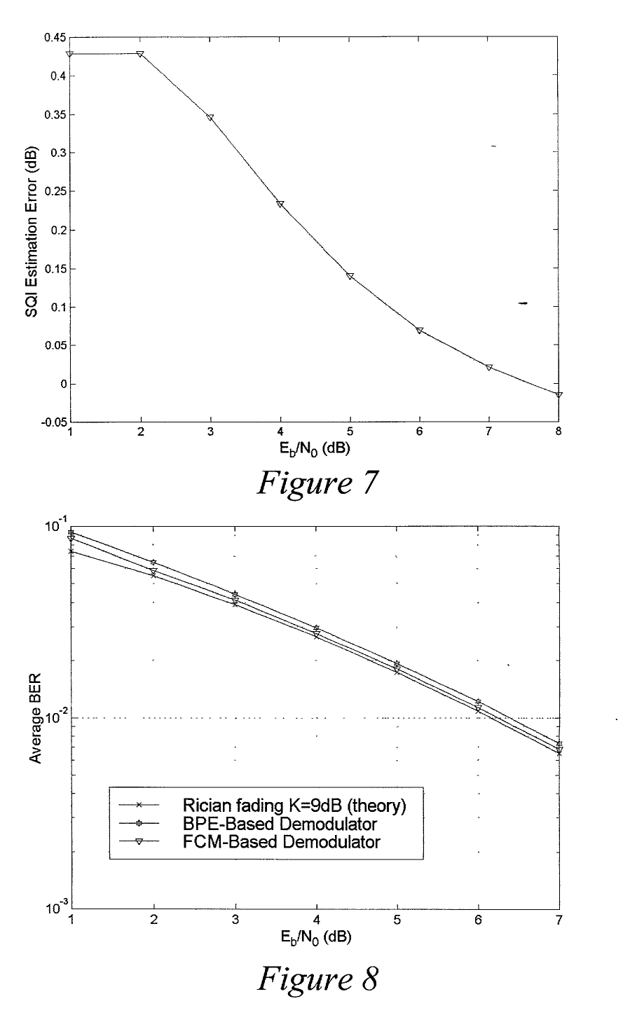

In FIG. 7, a plot of the average SQI estimation error (in dB) versus the actual E_{b}/N₀ (dB) for 5,000 bursts is shown. From FIG. 7, it is observed that the error is quite small especially for high E_{b}/N₀, which means that our FCM-based clustering can be used to estimate the SQI and evaluate the link quality.

The FCM-based demodulator 204 of the present invention using, for example, Bayesian demodulation was compared against a block phase estimation (BPE)-based demodulator [6] and the results are shown in FIG. 8. BPE is a semi-blind demodulator, which uses a maximum-likelihood method to estimate a phase gain of a channel and then uses a known sequence (e.g., 5 QPSK unique words) to remove phase ambiguity because of an inverse-tangent function used in the phase estimation. This method has been widely used in mobile communications with burst transmission.

For such a channel, simulations for different E_{b}/N₀ values were performed. At each E_{b}/N₀ value, the simulations for 5000 bursts were ran and the average bit error rate (BER) for the FCM-based Bayesian demodulator and BPE-based demodulator were obtained. The performances are plotted in FIG. 8. Also plotted was the theoretical BER at K=9 dB. From FIG. 8, it is observed that the FCM-based demodulator 204 of the present invention performs better than the BPE-based demodulator, achieving a gain of 0.2 dB and approaching the theoretical BER.

The present invention stores information relating to various processes described herein. This information is stored in one or more memories, such as a hard disk, optical disk, magneto-optical disk, RAM, etc. One or more databases, such as the databases within the systems 104, 108 and 112, etc., may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 9, for example.

The previously described processes include appropriate data structures for storing data collected and/or generated by the processes of the system 100 of FIG. 1 in one or more databases thereof. Such data structures accordingly will includes fields for storing such collected and/or generated data. In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology. Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

The present invention (e.g., as described with respect to FIGS. 1-8) may be implemented by the preparation of application-specific integrated circuits or by interconnecting an appropriate network of conventional component circuits, as will be appreciated by those skilled in the electrical art(s). In addition, all or a portion of the invention (e.g., as described with respect to FIGS. 1-8) maybe conveniently implemented using one or more conventional general purpose computers, microprocessors, digital signal processors, micro-controllers, etc., programmed according to the teachings of the present invention (e.g., using the computer system of FIG. 9), as will be appreciated by those skilled in the computer and software art(s). Appropriate software can be readily prepared by programmers of ordinary skill based on the teachings of the present disclosure, as will be appreciated by those skilled in the software art. Further, the present invention may be implemented on the World Wide Web (e.g., using the computer system of FIG. 9).

FIG. 9 illustrates a computer system 901 upon which the present invention (e.g., systems 104, 108, 112, etc.) can be implemented. The present invention may be implemented on a single such computer system, or a collection of multiple such computer systems. The computer system 901 includes a bus 902 or other communication mechanism for communicating information, and a processor 903 coupled to the bus 902 for processing the information. The computer system 901 also includes a main memory 904, such as a random access memory (RAM), other dynamic storage device (e.g., dynamic RAM (DRAM), static RAM (SRAM), synchronous DRAM (SDRAM)), etc., coupled to the bus 902 for storing information and instructions to be executed by the processor 903. In addition, the main memory 904 can also be used for storing temporary variables or other intermediate information during the execution of instructions by the processor 903. The computer system 901 further includes a read only memory (ROM) 905 or other static storage device (e.g., programmable ROM (PROM), erasable PROM (EPROM), electrically erasable PROM (EEPROM), etc.) coupled to the bus 902 for storing static information and instructions.

The computer system 901 also includes a disk controller 906 coupled to the bus 902 to control one or more storage devices for storing information and instructions, such as a magnetic hard disk 907, and a removable media drive 908 (e.g., floppy disk drive, read-only compact disc drive, read/write compact disc drive, compact disc jukebox, tape drive, and removable magneto-optical drive). The storage devices may be added to the computer system 901 using an appropriate device interface (e.g., small computer system interface (SCSI), integrated device electronics (IDE), enhanced-IDE (E-IDE), direct memory access (DMA), or ultra-DMA).

The computer system 901 may also include special purpose logic devices 918, such as application specific integrated circuits (ASICs), fall custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, satellite communications transceiver functions, the demodulator 204 functions, etc.

The computer system 901 may also include a display controller 909 coupled to the bus 902 to control a display 910, such as a cathode ray tube (CRT), liquid crystal display (LCD), active matrix display, plasma display, touch display, etc., for displaying or conveying information to a computer user. The computer system includes input devices, such as a keyboard 911 including alphanumeric and other keys and a pointing device 912, for interacting with a computer user and providing information to the processor 903. The pointing device 912, for example, may be a mouse, a trackball, a pointing stick, etc., or voice recognition processor, etc., for communicating direction information and command selections to the processor 903 and for controlling cursor movement on the display 910. In addition, a printer may provide printed listings of the data structures/information of the system shown in FIGS. 1-8, or any other data stored and/or generated by the computer system 901.

The computer system 901 performs a portion or all of the processing steps of the invention in response to the processor 903 executing one or more sequences of one or more instructions contained in a memory, such as the main memory 904. Such instructions may be read into the main memory 904 from another computer readable medium, such as a hard disk 907 or a removable media drive 908. Execution of the arrangement of instructions contained in the main memory 904 causes the processor 903 to perform the process steps described herein. One or more processors in a multi-processing arrangement may also be employed to execute the sequences of instructions contained in main memory 904. In alternative embodiments, hard-wired circuitry may be used in place of or in combination with software instructions. Thus, embodiments are not limited to any specific combination of hardware circuitry and software.

Stored on any one or on a combination of computer readable media, the present invention includes software for controlling the computer system 901, for driving a device or devices for implementing the invention, and for enabling the computer system 901 to interact with a human user (e.g., a user of the systems 104, 108, 112, etc.). Such software may include, but is not limited to, device drivers, operating systems, development tools, and applications software. Such computer readable media further includes the computer program product of the present invention for performing all or a portion (if processing is distributed) of the processing performed in implementing the invention. Computer code devices of the present invention may be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention may be distributed for better performance, reliability, and/or cost.

The computer system 901 also includes a communication interface 913 coupled to the bus 902. The communication interface 913 provides a two-way data communication coupling to a network link 914 that is connected to, for example, a local area network (LAN) 915, or to another communications network 916 such as the internet. For example, the communication interface 913 may be a digital subscriber line (DSL) card or modem, an integrated services digital network (ISDN) card, a cable modem, a telephone modem, etc., to provide a data communication connection to a corresponding type of telephone line. As another example, communication interface 913 may be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 913 sends and receives electrical, electromagnetic, or optical signals that carry digital data streams representing various types of information. Further, the communication interface 913 can include peripheral interface devices, such as a Universal Serial Bus (USB) interface, a PCMCIA (Personal Computer Memory Card International Association) interface, etc.

The network link 914 typically provides data communication through one or more networks to other data devices. For example, the network link 914 may provide a connection through local area network (LAN) 915 to a host computer 917, which has connectivity to a network 916 (e.g. a wide area network (WAN) or the global packet data communication network now commonly referred to as the “Internet”) or to data equipment operated by service provider. The local network 915 and network 916 both use electrical, electromagnetic, or optical signals to convey information and instructions. The signals through the various networks and the signals on network link 914 and through communication interface 913, which communicate digital data with computer system 901, are exemplary forms of carrier waves bearing the information and instructions.

The computer system 901 can send messages and receive data, including program code, through the network(s), network link 914, and communication interface 913. In the Internet example, a server (not shown) might transmit requested code belonging an application program for implementing an embodiment of the present invention through the network 916, LAN 915 and communication interface 913. The processor 903 may execute the transmitted code while being received and/or store the code in storage devices 907 or 908, or other non-volatile storage for later execution. In this manner, computer system 901 may obtain application code in the form of a carrier wave. With the system of FIG. 9, the present invention may be implemented on the Internet as a Web Server 901 performing one or more of the processes according to the present invention for one or more computers coupled to the Web server 901 through the network 916 coupled to the network link 914.

The term “computer readable medium” as used herein refers to any medium that participates in providing instructions to the processor 903 for execution. Such a medium may take many forms, including but not limited to, non-volatile media, volatile media, transmission media, etc. Non-volatile media include, for example, optical or magnetic disks, magneto-optical disks, etc., such as the hard disk 907 or the removable media drive 908. Volatile media include dynamic memory, etc., such as the main memory 904. Transmission media include coaxial cables, copper wire, fiber optics, including the wires that make up the bus 902. Transmission media can also take the form of acoustic, optical, or electromagnetic waves, such as those generated during radio frequency (RF) and infrared (IR) data communications. As stated above, the computer system 901 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer connected to either of networks 915 and 916. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Recapitulating, the present invention, advantageously, provides a demodulator 204 (e.g., using Bayesian demodulation, etc.) including a link adaptation scheme that may be employed, for example, in satellite-based General Packet Radio Services (GPRS) wireless network. The received signal of a satellite-based GPRS channel may be approximated by Gaussian distributions and then the demodulator 204 based on such distributions may be implemented. The average signal and noise powers in one GPRS burst may be estimated using an unsupervised clustering method, such as fuzzy c-means (FCM), etc. Based on the estimated signal level and noise standard deviation, a signal quality indicator (SQD may be evaluated and the parameters associated with the demodulator 204 may be implemented. The demodulation scheme uses link adaptation results, which simplifies the system design tremendously, as compared to conventional demodulators. Simulation results show that the link adaptation scheme works well and that the demodulator 204 of the present invention performs better than a block phase estimation (BPE) demodulator, achieving a gain of 0.2 dB.

The demodulator 204 of the present invention may be employed, for example, in an Inmarsat [9] multimedia communications system. Since the Bayesian demodulator typically obtains a 0.2 dB gain over the existing BPE demodulator, it can save millions of dollars in the satellite communications costs. The demodulator described in [8] is a training-based demodulator, wherein the number of unique words typically cannot be too small and the unique words typically may be located at several different locations (i.e., not in one place) in a burst so that the channel characteristics may be captured. The demodulator 204 of the present invention typically does not suffer from such constraints.

Although the present invention is described in terms of a demodulator used in a Quadrature Phase Shift Keying (QPSK) modulation environment, the present invention is applicable to other modulation environments, such as M-ary Phase-Shift Keying (M-PSK), Quadrature Amplitude Modulation (QAM), Pulse Amplitude Modulation (PAM), etc., as will be appreciated by those skilled in the relevant art(s).

Although the present invention is described in terms of a demodulator used in a system using a satellite communications channel, the present invention is applicable to other systems that may employ a demodulator using other communications channels, such as a digital video broadcasting (DVB) communications channel, a terrestrial broadcast communications channel, a cellular communications channel, a Quadrature Phase Shift Keying (QPSK) communications channel, an M-ary Phase-Shift Keying (M-PSK) communications channel, a Quadrature Amplitude Modulation (QAM) communications channel, a Pulse Amplitude Modulation (PAM) communications channel, etc., as will be appreciated by those skilled in the relevant art(s).

Although the present invention is described in terms of a demodulator using Bayesian demodulation techniques, the present invention is applicable to other types of demodulation techniques, as will be appreciated by those skilled in the relevant art(s).

While the present invention has been described in connection with a number of embodiments and implementations, the present invention is not so limited but rather covers various modifications and equivalent arrangements, which fall within the purview of the appended claims.

### LIST OF REFERENCES

[1] C. Ash, “The Probability Tutoring Book,” IEEE Press, New York, pp. 205-206, 1993.

[2] J. C. Bezdek, “Pattern Recognition with Fuzzy Objective Function Algorithms,” Plenum Press, New York, 1991.

[3] W. C. Jakes, “Microwave Mobile Communication,” New York, N.Y.: IEEE Press, 1993.

[4] B.-J. Kim, and D. C. Cox, “Blind equalization for short burst wireless communications,” IEEE Trans. on Vehicular Technology, vol. 49, no. 4, pp. 1235-1247, July 2000.

[5] G. L. Stuber, “Principles of Mobile Communications,” 2nd Edition, Kluwer Academic Publishers, Norwell, Mass., 2001.

[6] A. J. Viterbi, and A. M. Viterbi, “Nonlinear estimation of PSK modulated carrier phase with application to burst digital transmission,” IEEE Trans. Information Theory, vol. 32, pp. 432-451, July 1983.

[7] An enhancement to the GSM mobile communications system that supports data packets. GPRS enables continuous flows of IP data packets over the system for such applications as Web browsing and file transfer. GPRS differs from GSM's short messaging service (GSM-SMS), which is limited to messages of 160 bytes in length.

[8] U.S. patent application Ser. No. 09/978,291 of Liang et al, entitled “Method, Device and Computer Program Product for a Demodulator Using a Fuzzy Adaptive Filter (FAF) and Decision Feedback,” filed on Oct. 16, 2001.

[9] (Inmarsat, London, inmarsat.org on the World Wide Web) Formerly International Maritime Satellite, it is an international organization founded in 1979 to provide global satellite communications to the maritime industry. Today, it provides satellite service to ships, planes, trains, offshore rigs and mobile phones. COMSAT is the U.S. signatory to Inmarsat.

What is claimed is:

1. A demodulator with communications link adaptation for use in a communications channel, comprising:
said demodulator configured to receive a modulated signal over the communications channel;
said demodulator configured to extract clusters from said modulated signal based on an unsupervised clustering technique;
said demodulator configured to compute a mean and standard deviation for each extracted cluster;
said demodulator configured to determine categories for each extracted cluster based on a training sequence included in said modulated signal; and
said demodulator configured to demodulate said modulated signal based on said mean, said standard deviation and said determined categories.

2. The demodulator of claim 1, wherein said demodulator is configured to demodulate said modulated signal using a Bayesian demodulation technique.

3. The demodulator of claim 1, wherein said unsupervised clustering technique comprises a Fuzzy c-Means (FCM) clustering technique.

4. The demodulator of claim 1, wherein said modulated signal comprises a Quadrature Phase Shift Keying (QPSK) modulated signal.

5. The demodulator of claim 4, wherein said categories comprise +1, +j, −1 and −j.

6. The demodulator of claim 5, wherein said demodulator is configured to assign an extracted cluster to said category +1 and remaining extracted clusters to categories +j, −1 and −j in a counterclockwise order from said cluster assigned to said category 1.

7. The demodulator of claim 1, wherein said demodulator is configured to generate hard decisions as said demodulation is used downstream for at least one of burst extraction and payload extraction.

8. The demodulator of claim 1, wherein said communications channel comprises a satellite communications channel.

9. The demodulator of claim 8, wherein said satellite communications channel comprises a satellite downlink communications channel.

10. The demodulator of claim 1, wherein said communications channel comprises one of a digital video broadcasting (DVB) communications channel, a terrestrial broadcast communications channel, a cellular communications channel, a Quadrature Phase Shift Keying (QPSK) communications channel, an M-ary Phase-Shift Keying (M-PSK) communications channel, a Quadrature Amplitude Modulation (QAM) communications channel, a Pulse Amplitude Modulation (PAM) communications channel.

11. The demodulator of claim 1, wherein said demodulator is included in a device comprising one of a personal digital assistant (PDA), a personal information assistant (PIA), a personal computer (PC), a laptop PC, a television, an Internet appliance, a cellular phone and a set-top box.

12. A communications system configured to include said demodulator recited in any one of claims 1-11.

13. A demodulation method with communications link adaptation for use in a communications channel, comprising:
receiving a modulated signal over the communications channel;
extracting clusters from said modulated signal based on an unsupervised clustering technique;
computing a mean and standard deviation for each extracted cluster;
determining categories for each extracted cluster based on a training sequence included in said modulated signal; and
demodulating said modulated signal based on said mean, said standard deviation and said determined categories.

14. The method of claim 13, wherein said demodulating step comprises using a Bayesian demodulation technique.

15. The method of claim 13, wherein said extracting step comprises using a Fuzzy c-Means (FCM) clustering technique.

16. The method of claim 13, further comprising configuring said modulated signal as a Quadrature Phase Shift Keying (QPSK) modulated signal.

17. The method of claim 16, further comprising configuring said categories as +1, +j, −1 and −j.

18. The method of claim 17, further comprises:
assigning an extracted cluster to said category +1; and
assigning remaining extracted clusters to categories +j, −1 and −j in a counterclockwise order from said cluster assigned to said category 1.

19. The method of claim 13, wherein said demodulating step comprises generating hard decisions used downstream for at least one of burst extraction and payload extraction.

20. The method of claim 13, further comprising configuring said communications channel as a satellite communications channel.

21. The method of claim 20, further comprising configuring said satellite communications channel as a satellite downlink communications channel.

22. The method of claim 13, further comprising configuring said communications channel as one of a digital video broadcasting (DVB) communications channel, a terrestrial broadcast communications channel, a cellular communications channel, a Quadrature Phase Shift Keying (QPSK) communications channel, an M-ary Phase-Shift Keying (M-PSK) communications channel, a Quadrature Amplitude Modulation (QAM) communications channel, a Pulse Amplitude Modulation (PAM) communications channel.

23. The method of claim 13, further comprising including said demodulation method in a device comprising one of a personal digital assistant (PDA), a personal information assistant (PIA), a personal computer (PC), a laptop PC, a television, an Internet appliance, a cellular phone and a set-top box.

24. A computer-readable medium carrying one or more sequences of one or more instructions for a demodulation method with communications link adaptation, the one or more sequences of one or more instructions including instructions which, when executed by one or more processors, cause the one or more processors to perform the steps recited in any one of claims 13-23.

25. A demodulation apparatus with communications link adaptation for use in a communications channel, comprising:
means for receiving a modulated signal over the communications channel;
means for extracting clusters from said modulated signal based on an unsupervised clustering technique;
means for computing a mean and standard deviation for each extracted cluster;
means for determining categories for each extracted cluster based on a training sequence included in said modulated signal; and
means for demodulating said modulated signal based on said mean, said standard deviation and said determined categories.
